(19) United States
(12) Patent Application Publication
(10) Pub. No.: US 2024/0406763 A1
(43) Pub. Date: Dec. 5, 2024

(54) COMMUNICATION METHOD, TERMINAL, COMMUNICATIONS DEVICE, AND NETWORK DEVICE

(71) Applicant: GUANGDONG OPPO MOBILE TELECOMMUNICATIONS CORP., LTD., Dongguan (CN)

(72) Inventors: Boyuan ZHANG, Dongguan (CN); Qianxi LU, Dongguan (CN); Bingxue LENG, Dongguan (CN)

(21) Appl. No.: 18/804,664

(22) Filed: Aug. 14, 2024

Related U.S. Application Data
(63) Continuation of application No. PCT/CN2022/093462, filed on May 18, 2022.

(51) Int. Cl. H04W 24/02; H04W 8/00; H04W 24/08

(52) U.S. Cl. CPC H04W 24/02; H04W 8/005; H04W 24/08

(57) ABSTRACT

A communication method, a terminal, a communications device, and a network device are provided. The communication method includes: receiving, by a first terminal, first information, where the first information is used to indicate first link information between a second communications device and a third terminal. When the first terminal performs relay selection or reselection, the first link information may help the first terminal determine whether to select the second communications device as a relay device from the first terminal to the third terminal. In other words, when selecting a relay device, the first terminal can consider a status of a link between a candidate relay device and a target remote terminal

### CROSS-REFERENCE TO RELATED APPLICATIONS

This application is a continuation of International Application No. PCT/CN2022/093462, filed on May 18, 2022, the disclosure of which is hereby incorporated by reference in its entirety.

### TECHNICAL FIELD

This application relates to the technical field of communications, and more specifically, to a communication method, a terminal, a communications device, and a network device.

### BACKGROUND

In terminal-to-terminal relaying, a relay selection process needs to be implemented to select a suitable relay device (for example, a relay terminal). In a related technology, a source remote terminal may determine, based on quality of a link between the source remote terminal and a candidate relay device, whether to select the device as a relay device. Based on this method, if there is an anomaly in a link (for example, quality of the link is low) between a selected relay device and a target remote terminal, a failure in service forwarding may be caused.

### SUMMARY

This application provides a communication method, a terminal, a communications device, and a network device. This application is described in the following several aspects.

According to a first aspect, a communication method is provided. The communication method includes: receiving, by a first terminal, first information, where the first information is used to indicate first link information between a second communications device and a third terminal.

According to a second aspect, a communication method is provided. The communication method includes: sending, by a second communications device, first information to a first terminal, where the first information is used to indicate first link information between the second communications device and a third terminal.

According to a third aspect, a communication method is provided. The communication method includes: obtaining, by a third terminal, first link information between the third terminal and a second communications device, where the first link information is used by a first terminal to determine whether the second communications device is a relay terminal.

According to a fourth aspect, a communication method is provided. The communication method includes: sending, by a network device, third information to a first terminal, where the third information is used to indicate first configuration information, whether to select a second communications device as a relay terminal is determined based on the first configuration information and first link information, and the first link information is information about a link between the second communications device and a third terminal.

According to a fifth aspect, a terminal is provided. The terminal is a first terminal, and the terminal includes a first receiving unit, configured to receive first information, where the first information is used to indicate first link information between a second communications device and a third terminal.

According to a sixth aspect, a communications device is provided. The communications device is a second communications device, and includes a first sending unit, configured to send first information to a first terminal, where the first information is used to indicate first link information between the second communications device and a third terminal.

According to a seventh aspect, a terminal is provided. The terminal is a third terminal, and the terminal includes a first obtaining unit, configured to obtain first link information between the third terminal and a second communications device, where the first link information is used by a first terminal to determine whether the second communications device is a relay terminal.

According to an eighth aspect, a network device is provided. The network device includes a third sending unit, configured to send third information to a first terminal, where the third information is used to indicate first configuration information, whether to select a second communications device as a relay terminal is determined based on the first configuration information and first link information, and the first link information is information about a link between the second communications device and a third terminal.

According to a ninth aspect, a terminal device is provided, including a processor, a memory, and a communications interface. The memory is configured to store one or more computer programs, and the processor is configured to invoke the computer program in the memory to cause the terminal device to execute the method according to the first aspect or the third aspect.

According to a tenth aspect, a communications device is provided, including a processor, a memory, and a communications interface. The memory is configured to store one or more computer programs, and the processor is configured to invoke the computer program in the memory to cause the terminal device to execute the method according to the second aspect.

According to an eleventh aspect, a network device is provided, including a processor, a memory, and a communications interface. The memory is configured to store one or more computer programs, and the processor is configured to invoke the computer program in the memory to cause the network device to execute the method according to the fourth aspect.

According to a twelfth aspect, an embodiment of this application provides a communications system. The system includes at least one of the terminal device, the communications device, and the network device described above. In another possible design, the system may further include another device that interacts with the terminal, the communications device, or the network device in the solutions provided in embodiments of this application.

According to a thirteenth aspect, an embodiment of this application provides a computer-readable storage medium. The computer-readable storage medium stores a computer program, and the computer program causes a terminal device to execute some or all of the steps of the method according to the first aspect or the third aspect.

According to a fourteenth aspect, an embodiment of this application provides a computer-readable storage medium. The computer-readable storage medium stores a computer program, and the computer program causes a terminal device to execute some or all of the steps of the method according to the second aspect.

According to a fifteenth aspect, an embodiment of this application provides a computer-readable storage medium. The computer-readable storage medium stores a computer program, and the computer program causes a network device to execute some or all of the steps of the method according to the fourth aspect.

According to a sixteenth aspect, an embodiment of this application provides a computer program product. The computer program product includes a non-transitory computer-readable storage medium that stores a computer program, and the computer program is operable to cause a terminal to execute some or all of the steps of the method according to the first aspect or the third aspect. In some implementations, the computer program product may be a software installation package.

According to a seventeenth aspect, an embodiment of this application provides a computer program product. The computer program product includes a non-transitory computer-readable storage medium that stores a computer program. The computer program is operable to cause a terminal to execute some or all of the steps in the method according to the second aspect. In some implementations, the computer program product may be a software installation package.

According to an eighteenth aspect, an embodiment of this application provides a computer program product. The computer program product includes a non-transitory computer-readable storage medium that stores a computer program. The computer program is operable to cause a network device to execute some or all of the steps in the method according to the fourth aspect. In some implementations, the computer program product may be a software installation package.

According to a nineteenth aspect, an embodiment of this application provides a chip. The chip includes a memory and a processor, and the processor may invoke a computer program from the memory and run the computer program, so as to implement some or all of the steps described in the method according to the first aspect, the second aspect, the third aspect, or the fourth aspect.

According to a twentieth aspect, a computer program product is provided, including a program, where the program causes a computer to execute the method according to the first aspect, the second aspect, or the third aspect.

According to a twenty-first aspect, a computer program product is provided, including a program, where the program causes a computer to execute the method according to the fourth aspect.

According to a twenty-second aspect, a computer program is provided, where the computer program causes a computer to execute the method according to the first aspect, the second aspect, or the third aspect.

According to a twenty-third aspect, a computer program is provided, where the computer program causes a computer to execute the method according to the fourth aspect.

When a first terminal performs relay selection or reselection, first link information may help the first terminal determine whether to select a second communications device as a relay device from the first terminal to a second terminal. In other words, when selecting a relay device, the first terminal can consider a status of a link between a candidate relay device and a target remote terminal.

### BRIEF DESCRIPTION OF DRAWINGS

FIG. 1 shows a wireless communications system 100 to which an embodiment of this application is applied.

FIG. 2 is an example diagram of a scenario of sidelink communication within network coverage.

FIG. 3 is an example diagram of a scenario of sidelink communication partially within network coverage.

FIG. 4 is an example diagram of a scenario of sidelink communication out of network coverage.

FIG. 5 is an example diagram of a scenario of terminal-to-terminal relaying.

FIG. 6 is a schematic flowchart of a communication method according to an embodiment of this application.

FIG. 7 is a schematic flowchart of another communication method according to an embodiment of this application.

FIG. 8 is a schematic flowchart of another communication method according to an embodiment of this application.

FIG. 9 is a schematic flowchart of another communication method according to an embodiment of this application.

FIG. 10 is a schematic diagram of a scenario to which an embodiment of this application is applicable.

FIG. 11 is a schematic structural diagram of a terminal according to an embodiment of this application.

FIG. 12 is a schematic structural diagram of a communications device according to an embodiment of this application.

FIG. 13 is a schematic structural diagram of another terminal according to an embodiment of this application.

FIG. 14 is a schematic structural diagram of a network device according to an embodiment of this application.

FIG. 15 is a schematic structural diagram of a communications apparatus according to an embodiment of this application.

### DESCRIPTION OF EMBODIMENTS

The technical solutions in this application are described below with reference to the accompanying drawings.

### Communications System

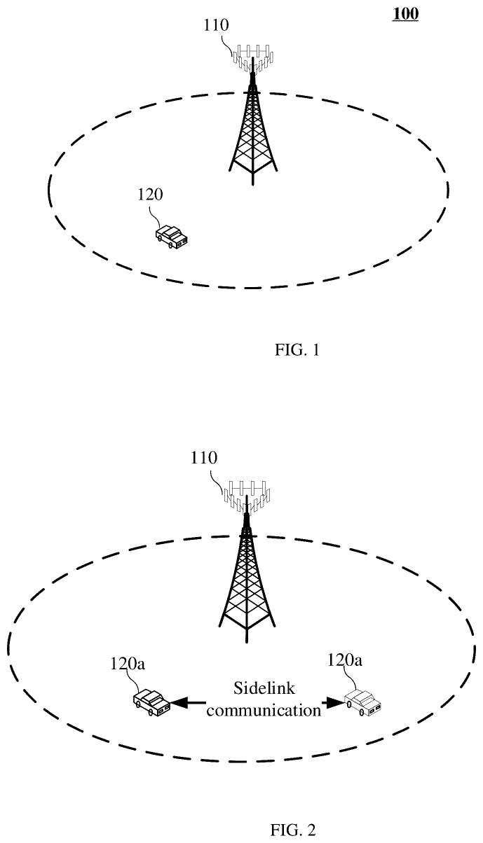

FIG. 1 shows a wireless communications system 100 to which an embodiment of this application is applied. The wireless communications system 100 may include a network device 110 and a terminal device 120. The network device 110 may be a device that communicates with the terminal device 120. The network device 110 may provide communication coverage for a specific geographic area, and may communicate with the terminal device 120 located within the coverage.

In at least one embodiment, the wireless communications system 100 may include a plurality of network devices, and another quantity of terminal devices may be included within coverage of each network device, which is not limited in embodiments of this application.

In at least one embodiment, the wireless communications system 100 may further include other network entities such as a network controller and a mobility management entity, which is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and LTE time division duplex (TDD). The technical solutions provided in this application may further be applied to a future communications system, such as a sixth generation mobile communications system or a satellite communications system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like. In at least one embodiment, the terminal device may be configured to serve as a base station. For example, the terminal device may act as a scheduling entity that provides a sidelink signal between terminal devices in vehicle-to-everything (V2X), device-to-device (D2D) communications, or the like. For example, a cellular phone and a vehicle communicate with each other by using a sidelink signal. A cellular phone and a smart home device communicate with each other, without relaying a communication signal by using a base station. In at least one embodiment, the terminal device may be configured to serve as a base station.

The network device in embodiments of this application may be a device configured to communicate with the terminal device. The network device may also be referred to as an access network device or a wireless access network device. For example, the network device may be a base station. The network device in embodiments of this application may be a radio access network (RAN) node (or device) that connects the terminal device to a wireless network. The base station may broadly cover various names in the following, or may be replaced with the following names: a NodeB, an evolved NodeB (CNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may refer to a communications module, a modem, or a chip disposed in the device or apparatus described above. Alternatively, the base station may be a mobile switching center, a device that functions as a base station in D2D, vehicle-to-vehicle (V2V), V2X, and machine-to-machine (M2M) communication, a network-side device in a 6G network, a device that functions as a base station in a future communications system, or the like. The base station may support networks with a same access technology or different access technologies. A specific technology and a specific device form used by the network device are not limited in embodiments of this application.

The base station may be stationary or mobile. For example, a helicopter or an unmanned aerial vehicle may be configured to function as a mobile base station, and one or more cells may move depending on a location of the mobile base station. In other examples, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. Scenarios in which the network device and the terminal device are located are not limited in embodiments of this application.

It should be understood that all or some of functions of the communications device in this application may also be implemented by software functions running on hardware, or by virtualization functions instantiated on a platform (for example, a cloud platform).

### Sidelink Communication in Different Network Coverage Statuses

Sidelink communication means a sidelink-based communication technology. Sidelink communication supports direct transmission of communication data between a terminal device and another terminal device. Direct transmission of the communication data between the terminal device and the other terminal device may have higher spectral efficiency and a lower transmission delay. For example, an Internet of vehicles system uses a sidelink communication technology.

Sidelink communication may be divided, depending on a network coverage status of the terminal device, into sidelink communication within network coverage, sidelink communication partially within network coverage, and sidelink communication out of network coverage.

FIG. 2 is an example diagram of a scenario of sidelink communication within network coverage. In the scenario shown in FIG. 2, two terminal devices 120a are both located within coverage of a network device 110. Therefore, both the two terminal devices 120a may receive configuration signalling (where the configuration signalling in this application may be replaced with configuration information) from the network device 110, and determine a sidelink configuration based on the configuration signalling from the network device 110. After performing sidelink configuration, both the two terminal devices 120a may perform sidelink communication on a sidelink.

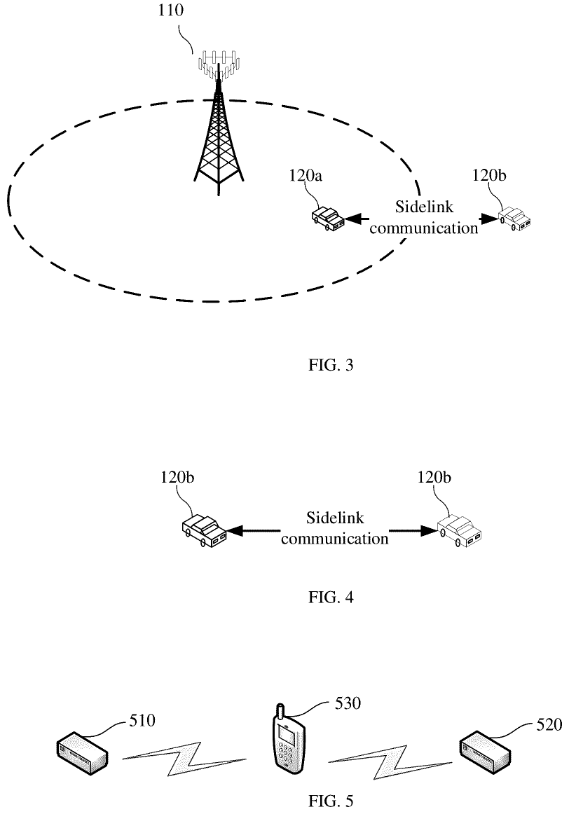

FIG. 3 is an example diagram of a scenario of sidelink communication partially within network coverage. In the scenario shown in FIG. 3, a terminal device 120a performs sidelink communication with a terminal device 120b. The terminal device 120a is located within coverage of a network device 110. Therefore, the terminal device 120a can receive configuration signalling from the network device 110, and determine a sidelink configuration based on the configuration signalling from the network device 110. The terminal device 120b is located out of network coverage, and cannot receive the configuration signalling from the network device 110. In this case, the terminal device 120b may determine a sidelink configuration based on preconfiguration information and/or information that is carried on a physical sidelink broadcast channel (PSBCH) and that is sent by the terminal device 120a located within the network coverage. After performing sidelink configuration, both the terminal device 120a and the terminal device 120b may perform sidelink communication on a sidelink.

FIG. 4 is an example diagram of a scenario of sidelink communication out of network coverage. In the scenario shown in FIG. 4, two terminal devices 120b are both located out of network coverage. In this case, both the two terminal devices 120b may determine a sidelink configuration based on preconfiguration information. After performing sidelink configuration, both the two terminal devices 120b may perform sidelink communication on a sidelink.

### D2D

D2D may be implemented based on sidelink communication. Study stages of D2D may include near-field communication (ProSe), V2X, wearable devices (further enhancements to LTE device to device, FeD2D), and multi-carrier, which are separately described below.

In some communication protocols (for example, the 3rd Generation Partnership Project (3GPP) Rel-12/13), scenarios for ProSe are studied, and ProSe is mainly for public safety services. In ProSe, a location of a resource pool in time domain may be configured (for example, the resource pool is discontinuous in time domain), such that a terminal discontinuously sends and/or receives data on a sidelink. In this way, a power saving effect is achieved.

In some communication protocols (for example, 3GPP Rel-14/15), V2X is studied for vehicle-to-vehicle communication scenarios, which are mainly for services of communication between vehicles or between a vehicle and a person that move at a relatively high speed. In V2X, because a vehicle-mounted system has continuous power supply, power efficiency is not a major problem, and a latency of data transmission is a major problem. Therefore, a terminal device is required to perform continuous sending and receiving in a system design.

In some communication protocols (for example, 3GPP Rel-14), FeD2D is studied for a scenario in which a wearable device accesses a network by using a mobile phone, which is mainly for a scenario of a low moving speed and low power access. In FeD2D, a base station may configure a discontinuous reception (DRX) parameter of a remote terminal by using a relay terminal.

In some communication protocols (for example, 3GPP Rel-15), a multi-carrier mechanism is introduced. The multi-carrier mechanism is reflected in following aspects: A terminal may support data packet segmentation, to transmit data packets by using a plurality of carriers, so as to improve a data transmission rate; a terminal may support data packet duplication, to duplicate a same data packet into two copies, and send the copies by using two carriers, so as to improve transmission reliability; and enhanced multi-carrier reception at a receiving end may be supported. For data packet duplication: sidelink packet duplication is supported in V2X sidelink communication, and is performed at a packet data convergence protocol (PDCP) layer of a terminal. For sidelink packet duplication for transmission, a PDCP protocol data unit (PDU) may be duplicated at a PDCP entity. Duplicated PDCP PDUs of a same PDCP entity may be submitted to two different radio link control (RLC) entities and associated with two different sidelink logical channels, respectively. Duplicated PDCP PDUs of a same PDCP entity are only allowed to be transmitted on different sidelink carriers. A terminal may activate or deactivate sidelink packet duplication based on (pre) configuration. Sidelink data packet duplication is not applicable to transmission of files with some transmission configuration (for example, TS 23.285 [72] in Rel-14). A value of ProSe per-packet reliability (prose per-packet reliability, PPPR) supporting sidelink data packet duplication may be (pre) configured by using a PPPR threshold. For resource allocation involving independent resource selection and scheduling by a terminal, the terminal should perform sidelink packet duplication for data with configured PPPR values until packet duplication configuration is canceled for these PPPR values. For resource allocation involving scheduling, an amount of data associated with one or more PPPR values and a destination to which the data belongs may be reported by a terminal through a sidelink buffer status report (BSR). Mapping of PPPR values to logical channel groups may be configured by a network device, and the PPPR values are reflected by associated logical channel group IDs included in the sidelink BSR. A list of one or more PPPR values may be reported by a terminal connected via radio resource control (RRC) in sidelink terminal information.

### Mode of Sidelink Communication

In some standards or protocols (for example, 3GPP standards), two modes of sidelink communication (or referred to as modes of transmission) are defined: a first mode (or referred to as a mode A) and a second mode (or referred to as a mode B).

In the first mode, a resource for a terminal device is allocated by a network device. The terminal device may send data on a sidelink based on the resource allocated by the network device. The network device may allocate a resource for a single time of transmission to the terminal device, or may allocate a resource for semi-static transmission to the terminal device. For example, in the scenario shown in FIG. 2, the network device may allocate a resource to the terminal device 120a by using a downlink (DL) grant.

In the second mode, the terminal device may independently select one or more resources from a resource pool (RP). Then, the terminal device may perform sidelink transmission based on the selected resource. For example, in the scenario shown in FIG. 4, the terminal device 120b is located out of the cell coverage. Therefore, the terminal device 120b may independently select a resource from a preconfigured resource pool to perform sidelink transmission. Alternatively, in the scenario shown in FIG. 2, the terminal device 120a may independently select a resource from a resource pool configured by the network device 110, to perform sidelink transmission.

In at least one embodiment, in some communications systems (for example, an NR system), a terminal may be in a mixed mode. In the mixed mode, the terminal may obtain a resource in the first mode, or may obtain a resource in the second mode. The resource acquisition may be indicated by using a sidelink grant, that is, the sidelink grant indicates a time-frequency position of a corresponding physical sidelink control channel (PSCCH) resource and a corresponding physical sidelink shared channel (PSSCH) resource.

### Terminal-to-Terminal Relaying (UE-to-UE Relay)

In some communication protocols (for example, Rel-18), study on terminal-to-terminal relaying is part of study on sidelink.

Terminal-to-terminal relaying can extend coverage of sidelink communication transmission between terminals, and may further achieve power saving. A device that implements terminal-to-terminal relaying may be referred to as a relay device. The relay device may be a terminal. In this case, the terminal may be referred to as a relay terminal (relay UE). The relay terminal may be a relay between a source remote terminal (source UE) and a target remote terminal (destination UE).

Once a PC5 link is established between the source remote terminal, the relay terminal, and the target remote terminal, data may be relayed between the source remote terminal and the target remote terminal.

Coverage scenarios of terminal-to-terminal relaying may include following several cases.

(1) All the terminals (including the source remote terminal, the target remote terminal, and the relay terminal) are within coverage.

(2) All the terminals (including the source remote terminal, the target remote terminal, and the relay terminal) are out of coverage.

(3) Partial coverage: at least one of the terminals (including the source remote terminal, the target remote terminal, and the relay terminal) is within coverage, and at least one of the terminals is out of the coverage.

Some communication standard organizations (such as RAN2) are committed to providing common solutions for in-coverage and out-of-coverage scenarios. The terminal-to-terminal relaying may support a scenario in which a terminal is within coverage of different cells.

FIG. 5 is an example diagram of a scenario of terminal-to-terminal relaying. The scenario shown in FIG. 5 may include a source remote terminal 510, a target remote terminal 520, and a relay terminal 530. In FIG. 5, the source remote terminal 510 or the target remote terminal 520 and/or the relay terminal may be within the coverage, and may access a network via a Uu.

In some communications systems (for example, an NR system), a sidelink may include a PC5 link between one or more remote terminals (remote UE) and a relay terminal. The remote terminal may include a source remote terminal and a target remote terminal.

In some cases, Cross-RAT configuration or control of the source remote terminal, the relay terminal, and the target remote terminal may not be considered, that is, a network device (for example, an eNB/ng-eNB) may not control or configure the source remote terminal, the relay terminal, and the target remote terminal. In some cases, it may be assumed that the remote terminal has an active end-to-end connection only by using a single relay terminal at a given time.

It should be noted that there is no limitation on an RRC state of a terminal that participates in terminal-to-terminal relaying. A requirement for service continuity is only for terminal-to-network relaying and not for terminal-to-terminal relaying.

In terminal-to-terminal relaying, a relay selection process needs to be implemented to select a suitable relay device (for example, a relay terminal). In a related technology, a source remote terminal may determine, based on quality of a link between the source remote terminal and a candidate relay device, whether to select the device as a relay device. Based on this method, if there is an anomaly in a link (for example, quality of the link is low) between a selected relay device and a target remote terminal, a failure in service forwarding may be caused.

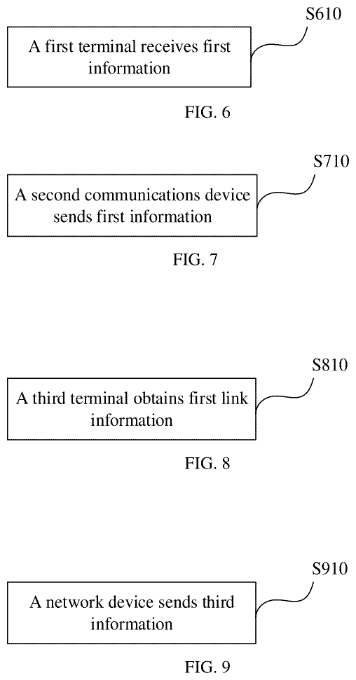

FIG. 6 is a schematic flowchart of a communication method according to an embodiment of this application, to solve a problem of inappropriate selection of a relay terminal. The embodiment shown in FIG. 6 may be executed by a first terminal. The method shown in FIG. 6 may include step S610.

In step S610, a first terminal receives first information.

The first information may be used to indicate first link information between a second communications device and a third terminal. The second communications device may be a terminal or a network device. In a case that the second communications device is a terminal, the second communications device may be referred to as a second terminal.

The first link information may be, for example, link quality information between the second communications device and the third terminal. The link quality information may be represented by, for example, a sidelink discovery reference signal received power SD-RSRP) and/or a sidelink reference signal received power (SL-RSRP). For example, if a PC5-RRC link is established between the second communications device and the third terminal, the link quality information may be obtained by measuring an SL-RSRP. If no PC5-RRC link is established between the second communications device and the third terminal, the link quality information may be obtained by measuring an SD-RSRP.

The first information may include one or more of following: an identity of the second communications device, an identity of the third terminal, a parameter of a first link between the second communications device and the third terminal, or a type of a parameter of a first link. The type of the parameter of the first link may be used to indicate a type to which the parameter of the first link belongs. That the first link information is the link quality information is used as an example. The type of the parameter of the first link may include, for example, SD-RSRP and/or SL-RSRP. Correspondingly, the parameter of the first link may be, for example, a quality, and the quality may include a measurement result of the SD-RSRP and/or a measurement result of the SL-RSRP.

The first information may include not only the first link information between the second communications device and the third terminal, but also link information between the second communications device and one or more other terminals. In a case that the first information includes information about a plurality of links, the first information may include one or more of following: identities of a plurality of terminals, types of information about the plurality of links, qualities of the plurality of links, or the like. As a possible implementation, the identities of the plurality of terminals may be reflected in the form of a list.

The first terminal may be a source remote terminal. The third terminal may be a target remote terminal. Sidelink communication may be performed between the first terminal and the third terminal. The first terminal may perform sidelink communication with the third terminal by using the second communications device. In other words, the second communications device may be used as a relay (for example, a relay terminal) from the first terminal to the third terminal. Before it is determined that the second communications device is selected as a relay device, the second communications device may be a candidate relay device.

The first terminal may obtain the first link information between the second communications device and the third terminal based on the first information. When the first terminal performs relay device selection or reselection, the first link information may help the first terminal determine whether to select the second communications device as a relay device. In other words, when selecting a relay device, the first terminal may consider a status of a link between a candidate relay device and a target remote terminal, so as to prevent the link between the relay device and the target remote terminal from causing a failure in service forwarding for sidelink communication.

That the first link information is link quality information is used as an example. When the first terminal performs relay terminal selection or reselection, quality of a link between the second communications device and the third terminal may be considered, to determine whether to select the second communications device as the relay device from the first terminal to the third terminal. For example, the first terminal may consider link quality of both of two sidelinks. The link quality of the two sidelinks may include quality of a link between the first terminal and the second communications device, and the quality of the link between the second communications device and the third terminal. In this way, a failure in service forwarding may be prevented from being caused by low quality of a link between a relay device and a target remote terminal.

A device that sends the first information is not limited in this application. The first information may be sent by using one or more of the second communications device, the third terminal, or a network device. For example, the second communications device may send the first information to the first terminal. Alternatively, the third terminal may send the first information to the second communications device, and the second communications device may send the received first information to the first terminal. Alternatively, the third terminal may send the first information to the network device, and the network device may send the first information to the first terminal. For example, the second communications device sends the first information, as shown in FIG. 7.

FIG. 7 is a schematic flowchart of a communication method according to an embodiment of this application. The method shown in FIG. 7 may be executed by the second communications device. The method shown in FIG. 7 may include step S710.

In step S710, the second communications device sends the first information.

The second communications device may directly send the first information to the first terminal, or may forward the first information to the first terminal by using another apparatus.

The second communications device may receive the first information determined by another device, and send the first information to the first terminal. In other words, the second communications device may forward the first information to the first terminal. For example, after receiving the first information, the second communications device may directly send the first information to the first terminal without performing any processing on the first information. Alternatively, the second communications device processes the received first information, and sends the processed first information to the first terminal. The processing of the first information by the second communications device may include, for example, confirming the first information. The second communications device may forward the first information to the first terminal after confirming the first information.

The first information may be carried in one or more of following messages: a discovery message, a discovery response message, a PC5-RRC message, a sidelink medium access control control element (SL MAC CE), or sidelink control information (SCI). For example, the second communications device may send the first information to the first terminal by using a broadcast discovery message. In a case that a PC5-RRC link is established between the second communications device and the first terminal, the second communications device may send the first information to the first terminal by using one or more of following messages: a PC5-RRC message, an SL MAC CE, or SCI.

The first link information may be obtained by the second communications device and/or the third terminal. The second communications device and/or the third terminal may obtain the first link information in an independent determining manner. Alternatively, the second communications device and/or the third terminal may receive the first link information determined by another device. A method for obtaining the first link information by the third terminal is described, referring to FIG. 8, for example.

FIG. 8 is a schematic flowchart of a communication method according to an embodiment of this application. The method shown in FIG. 8 may be executed by the third terminal. The method shown in FIG. 8 may include step S810.

In step S810, the third terminal obtains the first link information.

As an implementation, the third terminal may determine the first link information. The first link information is link quality information, for example. The third terminal may measure the quality of the link between the third terminal and the second communications device. For example, the third terminal may perform SD-RSRP measurement or SL-RSRP measurement.

The third terminal may feed back the first link information to the second communications device by using second information. For example, the second information may be carried in one or more of following messages: a discovery response message, a PC5-RRC message, an SL MAC CE, and SCI. In a case that no PC5-RRC link is established between the second communications device and the third terminal, the second information may be transmitted to the second communications device by using a discovery response message. In a case that a PC5-RRC link is established between the second communications device and the third terminal, the second information may be fed back to the second communications device by using one or more of following manners: a PC5-RRC message, an SL MAC CE, and SCI.

As another implementation, the third terminal may receive first link information determined by another device, to obtain the first link information. For example, the third terminal may receive the first link information determined by the second communications device.

As described above, the first link information may be determined by the third terminal, or may be determined by a third device and/or another device. A method for determining the first link information by the second communications device is described in detail below.

In an implementation, the first link information may be determined by the second communications device. That the first link information is link quality information is used as an example. The second communications device may measure the link between the second communications device and the third terminal, to determine the first link information. For example, the second communications device may perform SD-RSRP measurement and/or SL-RSRP measurement. In a case that a PC5-RRC link is established between the second communications device and the third terminal, the second communications device may perform SL-RSRP measurement. In a case that no PC5-RRC link is established between the second communications device and the third terminal, the second communications device may perform SD-RSRP measurement.

In an embodiment, the second communications device may obtain the first link information by measuring a discovery message and/or a discovery response message sent by the third terminal. That the first link information is link quality information is used as an example. The second communications device may measure link quality corresponding to the discovery message sent by the third terminal and/or link quality corresponding to the discovery response message sent by the third terminal, to obtain the first link information.

As described above, whether to select the second communications device as a relay terminal may be determined based on the first link information. The relay terminal may be configured to implement relaying from the first terminal to the third terminal. In other words, in a case that the second communications device is the relay terminal, the first terminal may implement terminal-to-terminal relaying by using the second communications device, so as to perform sidelink communication with the third terminal.

The selection of the relay terminal may further be determined based on first configuration information. In other words, the first terminal may determine, based on both the first link information and the first configuration information, whether to select the second communications device as the relay terminal.

The first link information may be used to indicate a quality of the first link between the second communications device and the third terminal. The first configuration information may include, for example, one or more of following: a first threshold, a second threshold, or a third threshold.

The first threshold may be a threshold value of the quality of the first link. The quality of the first link may be compared with the first threshold, to determine whether to select the second communications device as the relay terminal.

The second threshold may be a threshold value of a quality of a second link. The second link may be a link between the second communications device and the first terminal. The quality of the second link may be compared with the second threshold, to determine whether to select the second communications device as the relay terminal.

The third threshold may be a threshold value obtained by performing a first calculation on the quality of the first link and the quality of the second link. The first calculation may be performed on the quality of the first link and the quality of the second link to obtain a calculation result, and the calculation result may be compared with the third threshold, to determine whether to select the second communications device as the relay terminal. A specific calculation process or calculation method of the first calculation is not limited in this application. For example, the first calculation may be calculating an average value. A manner of calculating the average value may be, for example, (quality of the first link+quality of the second link)/2.

It should be noted that a manner of obtaining the quality of the second link is not limited in this application. Second link information may be determined by the first terminal and/or the second communications device. In some implementations, the second link information may be determined by measuring a link SD-RSRP of a discovery message and/or a discovery response message. For example, the first terminal may obtain the quality of the second link by measuring an SD-RSRP of a discovery message sent by the second communications device. In a case that a PC5-RRC link is established between the first terminal and the second communications device, the quality of the second link may be determined by measuring an SL-RSRP. For example, the first terminal may determine the quality of the second link by measuring an SL-RSRP between the first terminal and the second communications device.

The second communications device may be the relay terminal when one or more of following conditions are met: in a case that the first configuration information includes the first threshold, the quality of the first link is greater than or equal to the first threshold; in a case that the first configuration information includes the second threshold, the quality of the second link is greater than or equal to the second threshold; or in a case that the first configuration information includes the third threshold, a value obtained by performing the first calculation on the quality of the first link and the quality of the second link is greater than or equal to the third threshold.

It should be noted that whether to select the second communications device as the relay terminal may alternatively be determined according to other conditions or information. It may be understood that, in some cases, when the foregoing condition is met, the second communications device may be selected as the relay terminal. Alternatively, it may be determined that the second communications device is a candidate relay terminal, and the second communications device may be determined, as the relay terminal, from one or more candidate relay terminals according to other conditions or information.

In at least one embodiment, the first configuration information may be predefined in a communication protocol, or preconfigured, or may be dynamically configured. For example, in a case that the first terminal is out of coverage of the network device, the first configuration information may be preconfigured.

As an implementation, the first terminal may receive third information. The third information may be used to indicate the first configuration information.

A sender of the third information is not limited in this application. For example, the third information may be sent by the network device or the second communications device. That the third information is sent by the network device is described below by using FIG. 9 as an example.

FIG. 9 is a schematic flowchart of a communication method according to an embodiment of this application. The method shown in FIG. 9 may be executed by the network device. The method shown in FIG. 9 may include step S910.

In step S910, the network device sends the third information.

The third information may be carried in RRC signalling and/or a system broadcast message. For example, when the first terminal is in an RRC connected state, the third information may be carried in RRC dedicated signaling. Alternatively, when the first terminal is in an RRC idle state or RRC inactive state, the third information may be carried in a system broadcast message of the network device.

When the third information is sent by the second communications device, the third information may be carried in one or more of following messages: a PC5-RRC message, an SL MAC CE, or SCI. It may be understood that, when the third information is sent by the second communications device, a PC5-RRC link may be established between the second communications device and the first terminal, and the second communications device may be located within the coverage of the network device.

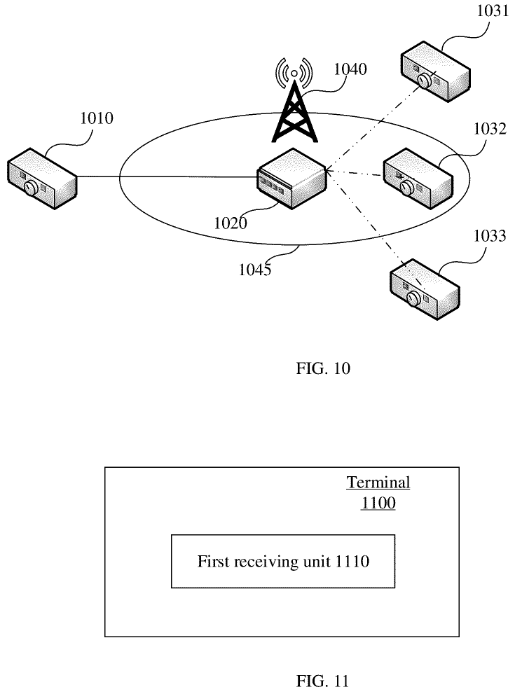

FIG. 10 is a schematic diagram of a scenario to which an embodiment of this application is applicable. The scenario shown in FIG. 10 includes a first terminal 1010, a second communications device 1020, a terminal 1031, a terminal 1032, a terminal 1033, and a network device 1040. Coverage of the network device may be represented by 1045. The third terminal may be the terminal 1031, the terminal 1032, or the terminal 1033. As shown in FIG. 10, a PC5 link is established between the first terminal 1010 and the second communications device 1020, and the second communications device 1020 is located within the coverage 1045. Therefore, in the scenario shown in FIG. 10, the third information may be sent by the second communications device.

As described above, a PC5-RRC link may be established between the second communications device and the third terminal. Establishment of the PC5-RRC link may be triggered by a first condition.

The first condition may include, for example, the quality of the first link being greater than or equal to a fourth threshold. It may be understood that, when the quality of the first link between the second communications device and the third terminal is greater than or equal to the fourth threshold, a PC5-RRC link may be established between the second communications device and the third terminal. For example, the quality of the first link information may be obtained by measuring an SD-RSRP. When a measurement result of SD-RSRP between the second communications device and the third terminal is greater than the fourth threshold, a PC5-RRC link may be established between the second communications device and the third terminal.

The fourth threshold may be configured in one or more of following manners: preconfiguration, configuration by using dedicated signalling, configuration by using a system broadcast, or configuration by broadcasting a discovery message.

A manner of configuring the fourth threshold is described below by using the third terminal as an example.

The network device may configure the fourth threshold for the third terminal. For example, when the third terminal is in an RRC connected state, the network device may configure the fourth threshold by using dedicated RRC signaling. Alternatively, when the third terminal is within the coverage of the network device and is in the RRC idle state or inactive state, the network device may deliver the fourth threshold by using a broadcast message.

The fourth threshold may be preconfigured. For example, when the third terminal is out of the coverage of the network device, the third terminal may obtain the fourth threshold through preconfiguration.

The second communications device may configure the fourth threshold for the third terminal. For example, the second communications device may send the fourth threshold in a discovery message when broadcasting the discovery message.

The method embodiments of this application are described in detail above with reference to FIG. 1 to FIG. 10. Apparatus embodiments of this application are described in detail below with reference to FIG. 11 to FIG. 15. It should be understood that the description of the method embodiments corresponds to the description of the apparatus embodiments, and therefore, for parts that are not described in detail, reference may be made to the foregoing method embodiments.

FIG. 11 is a schematic structural diagram of a terminal 1100 according to an embodiment of this application. The terminal 1100 may be a first terminal. The terminal 1100 may include a first receiving unit 1110.

The first receiving unit 1110 is configured to receive first information, where the first information is used to indicate first link information between a second communications device and a third terminal.

In at least one embodiment, the first link information is link quality information.

In at least one embodiment, the first link information is determined by the third terminal.

In at least one embodiment, the first link information is indicated to the second communications device by using second information.

In at least one embodiment, the second information is carried in one or more of following messages: a discovery response message, a PC5 radio resource control PC5-RRC message, a sidelink medium access control control element SL MAC CE, or sidelink control information SCI.

In at least one embodiment, the first link information is determined by the second communications device.

In at least one embodiment, the first link information is obtained by measuring a sidelink discovery reference signal received power SD-RSRP corresponding to a discovery message or a discovery response message.

In at least one embodiment, the terminal 1100 is further configured to determine, by the first terminal based on the first link information, whether to select the second communications device as a relay terminal.

In at least one embodiment, the selection of the relay terminal is further determined based on first configuration information.

In at least one embodiment, the first link information is used to indicate a quality of a first link between the second communications device and the third terminal, and the first configuration information includes one or more of following: a first threshold, a second threshold, or a third threshold, where the first threshold is a threshold value of the quality of the first link, the second threshold is a threshold value of a quality of a second link between the second communications device and the first terminal, and the third threshold is a threshold value obtained by performing a first calculation on the quality of the first link and the quality of the second link. In at least one embodiment, the first calculation is calculating an average value.

In at least one embodiment, the second communications device can be the relay terminal when one or more of following conditions are met: in a case that the first configuration information includes the first threshold, the quality of the first link is greater than or equal to the first threshold; in a case that the first configuration information includes the second threshold, the quality of the second link is greater than or equal to the second threshold; or in a case that the first configuration information includes the third threshold, a value obtained by performing the first calculation on the quality of the first link and the quality of the second link is greater than or equal to the third threshold.

In at least one embodiment, the terminal 1100 further includes a second receiving unit, configured to receive third information, where the third information is used to indicate the first configuration information.

In at least one embodiment, the third information is sent by a network device.

In at least one embodiment, the third information is carried in RRC signalling and/or a system broadcast message.

In at least one embodiment, the third information is sent by the second communications device.

In at least one embodiment, the third information is carried in one or more of following messages: a PC5-RRC message, an SL MAC CE, or SCI.

In at least one embodiment, the first configuration information is preconfigured.

In at least one embodiment, a PC5-RRC link is established between the second communications device and the third terminal, and establishment of the PC5-RRC link is triggered by a first condition.

In at least one embodiment, the first link information is used to indicate a quality of a first link between the second communications device and the third terminal, and the first condition includes that the quality of the first link is greater than or equal to a fourth threshold.

In at least one embodiment, the fourth threshold is configured in one or more of following manners: preconfiguration, configuration by using dedicated signalling, configuration by using a system broadcast, or configuration by broadcasting a discovery message.

In at least one embodiment, the first information includes one or more of following: an identity of the third terminal, a parameter of a first link between the second communications device and the third terminal, or a type of the parameter of the first link.

In at least one embodiment, the first information is carried in one or more of following messages: a discovery message, a discovery response message, a PC5-RRC message, an SL MAC CE, or SCI.

In at least one embodiment, the first link information includes a sidelink discovery reference signal received power SD-RSRP and/or a sidelink reference signal received power SL-RSRP.

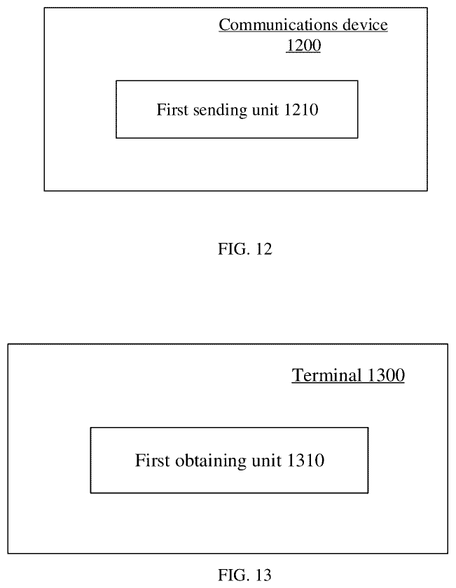

FIG. 12 is a schematic structural diagram of another communications device 1200 according to an embodiment of this application. The communications device 1200 may be a second communications device. The communications device 1200 may include a first sending unit 1210.

The first sending unit 1210 is configured to send first information to a first terminal, where the first information is used to indicate first link information between the second communications device and a third terminal.

In at least one embodiment, the first link information is link quality information.

In at least one embodiment, the first link information is determined by the third terminal.

In at least one embodiment, the first link information is indicated to the second communications device by using second information.

In at least one embodiment, the second information is carried in one or more of following messages: a discovery response message, a PC5 radio resource control PC5-RRC message, a sidelink medium access control control element SL MAC CE, or sidelink control information SCI.

In at least one embodiment, the first link information is determined by the second communications device.

In at least one embodiment, the first link information is obtained by measuring a sidelink discovery reference signal received power SD-RSRP corresponding to a discovery message or a discovery response message.

In at least one embodiment, whether to select the second communications device as a relay terminal is determined based on the first link information.

In at least one embodiment, the selection of the relay terminal is further determined based on first configuration information.

In at least one embodiment, the first link information is used to indicate a quality of a first link between the second communications device and the third terminal, and the first configuration information includes one or more of following: a first threshold, a second threshold, or a third threshold, where the first threshold is a threshold value of the quality of the first link, the second threshold is a threshold value of a quality of a second link between the second communications device and the first terminal, and the third threshold is a threshold value obtained by performing a first calculation on the quality of the first link and the quality of the second link.

In at least one embodiment, the first calculation is calculating an average value.

In at least one embodiment, the second communications device can be the relay terminal when one or more of following conditions are met: in a case that the first configuration information includes the first threshold, the quality of the first link is greater than or equal to the first threshold; in a case that the first configuration information includes the second threshold, the quality of the second link is greater than or equal to the second threshold; or in a case that the first configuration information includes the third threshold, a value obtained by performing the first calculation on the quality of the first link and the quality of the second link is greater than or equal to the third threshold.

In at least one embodiment, the communications device further includes a second sending unit, configured to send third information to the first terminal.

The third information is used to indicate the first configuration information.

In at least one embodiment, the third information is carried in one or more of following messages: a PC5-RRC message, an SL MAC CE, or SCI.

In at least one embodiment, a PC5-RRC link is established between the second communications device and the third terminal, and establishment of the PC5-RRC link is triggered by a first condition.

In at least one embodiment, the first link information is used to indicate a quality of a first link between the second communications device and the third terminal, and the first condition includes that the quality of the first link is greater than or equal to a fourth threshold.

In at least one embodiment, the fourth threshold is configured in one or more of following manners: preconfiguration, configuration by using dedicated signalling, configuration by using a system broadcast, or configuration by broadcasting a discovery message.

In at least one embodiment, the first information includes one or more of following: an identity of the third terminal, a parameter of a first link between the second communications device and the third terminal, or a type of the parameter of the first link.

In at least one embodiment, the first information is carried in one or more of following messages: a discovery message, a discovery response message, a PC5-RRC message, an SL MAC CE, or SCI.

In at least one embodiment, the first link information is an SD-RSRP and/or a sidelink reference signal received power SL-RSRP.

FIG. 13 is a schematic structural diagram of another terminal 1300 according to an embodiment of this application. The terminal 1300 may be a third terminal. The terminal 1300 may include a first obtaining unit 1310.

The first obtaining unit 1310 is configured to obtain first link information between the third terminal and a second communications device, where the first link information is used by the first terminal to determine whether the second communications device is a relay terminal.

In at least one embodiment, the first link information is link quality information.

In at least one embodiment, the first link information is measured by the third terminal.

In at least one embodiment, the first link information is sent to the second communications device by using second information.

In at least one embodiment, the second information is carried in one or more of following messages: a discovery response message, a PC5 radio resource control PC5-RRC message, a sidelink medium access control control element SL MAC CE, or sidelink control information SCI.

In at least one embodiment, a PC5-RRC link is established between the second communications device and the third terminal, and establishment of the PC5-RRC link is triggered by a first condition.

In at least one embodiment, the first link information is used to indicate a quality of a first link between the second communications device and the third terminal, and the first condition includes that the quality of the first link is greater than or equal to a fourth threshold.

In at least one embodiment, the fourth threshold is configured in one or more of following manners: preconfiguration, configuration by using dedicated signalling, configuration by using a system broadcast, or configuration by broadcasting a discovery message.

In at least one embodiment, the first link information includes a sidelink discovery reference signal received power SD-RSRP and/or a sidelink reference signal received power SL-RSRP.

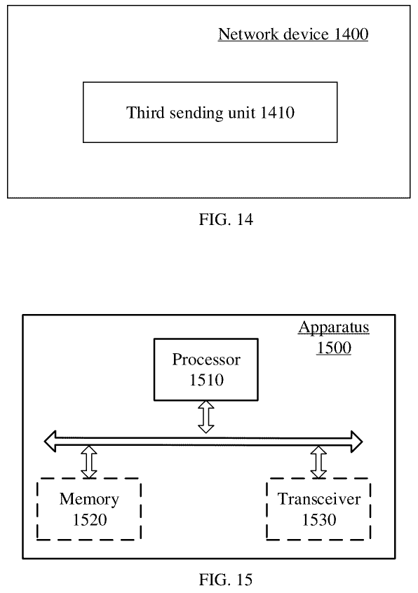

FIG. 14 is a schematic structural diagram of a network device 1400 according to an embodiment of this application. The network device 1400 may include a third sending unit 1410.

The third sending unit 1410 is configured to send third information to a first terminal, where the third information is used to indicate first configuration information, whether to select a second communications device as a relay terminal is determined based on the first configuration information and first link information, and the first link information is information about a link between the second communications device and a third terminal.

In at least one embodiment, the first link information is link quality information.

In at least one embodiment, the first link information is used to indicate a quality of a first link between the second communications device and the third terminal, and the first configuration information includes one or more of following: a first threshold, a second threshold, or a third threshold, where the first threshold is a threshold value of the quality of the first link, the second threshold is a threshold value of a quality of a second link between the second communications device and the first terminal, and the third threshold is a threshold value obtained by performing a first calculation on the quality of the first link and the quality of the second link.

In at least one embodiment, the first calculation is calculating an average value.

In at least one embodiment, the second communications device can be the relay terminal when one or more of following conditions are met: in a case that the first configuration information includes the first threshold, the quality of the first link is greater than or equal to the first threshold; in a case that the first configuration information includes the second threshold, the quality of the second link is greater than or equal to the second threshold; or in a case that the first configuration information includes the third threshold, a value obtained by performing the first calculation on the quality of the first link and the quality of the second link is greater than or equal to the third threshold.

In at least one embodiment, a PC5 radio resource control PC5-RRC link is established between the second communications device and the third terminal, and establishment of the PC5-RRC link is triggered by a first condition.

In at least one embodiment, the first link information is used to indicate a quality of a first link between the second communications device and the third terminal, and the first condition includes that the quality of the first link is greater than or equal to a fourth threshold.

In at least one embodiment, the fourth threshold is configured in one or more of following manners: preconfiguration, configuration by using dedicated signalling, configuration by using a system broadcast, or configuration by broadcasting a discovery message.

FIG. 15 is a schematic structural diagram of a communications apparatus according to an embodiment of this application. Dashed lines in FIG. 15 indicate that units or modules are optional. The apparatus 1500 may be configured to implement the methods described in the foregoing method embodiments. The apparatus 1500 may be a chip, a terminal device, or a network device.

The apparatus 1500 may include one or more processors 1510. The processor 1510 may allow the apparatus 1500 to implement the methods described in the foregoing method embodiments. The processor 1510 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1500 may further include one or more memories 1520. The memory 1520 stores a program that may be executed by the processor 1510 to cause the processor 1510 to execute the methods described in the foregoing method embodiments. The memory 1520 may be independent of the processor 1510 or may be integrated into the processor 1510.

The apparatus 1500 may further include a transceiver 1530. The processor 1510 may communicate with another device or chip through the transceiver 1530. For example, the processor 1510 may send data to and receive data from another device or chip by using the transceiver 1530.

An embodiment of this application further provides a computer-readable storage medium for storing a program. The computer-readable storage medium may be applied to a terminal or a network device provided in embodiments of this application, and the program causes a computer to execute the methods to be performed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods to be performed by the terminal or the network device in various embodiments of this application.

An embodiment of this application further provides a computer program. The computer program may be applied to a terminal or a network device provided in embodiments of this application, and the computer program causes a computer to execute the methods to be performed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned may be a direct indication or an indirect indication, or indicate an association. For example, if A indicates B, it may mean that A directly indicates B, for example, B can be obtained from A. Alternatively, it may mean that A indirectly indicates B, for example, A indicates C, and B can be obtained from C. Alternatively, it may mean that there is an association relationship between A and B.

In embodiments of this application, “B that corresponds to A” means that B is associated with A, and B may be determined based on A. However, it should also be understood that, determining B based on A does not mean determining B based only on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefined” or “preconfigured” may be implemented in a manner in which corresponding code, a table, or other related information that may be used for indication is pre-stored in a device (for example, including a terminal device and a network device). A specific implementation thereof is not limited in this application. For example, predefined may refer to being defined in a protocol.

In embodiments of this application, the “protocol” may refer to a standard protocol in the communication field, which may include, for example, an LTE protocol, an NR protocol, and a related protocol applied to a future communications system, and this application is not limited in this regard.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solution of this embodiment.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, wherein the communication method comprises:
receiving, by a first terminal, first information, wherein
the first information is used to indicate first link information between a second communications device and a third terminal.

2. The communication method according to claim 1, wherein the first link information is determined by the second communications device.

3. A terminal, wherein the terminal is a first terminal comprising a memory and a processor, wherein the memory is configured to store a program, and the processor is configured to invoke the program in the memory to cause the first terminal to perform:
receiving first information, wherein
the first information is used to indicate first link information between a second communications device and a third terminal.

4. The terminal according to claim 3, wherein the first link information is determined by the second communications device.

5. The terminal according to claim 4, wherein the first link information is obtained by measuring a sidelink discovery reference signal received power (SD-RSRP) corresponding to a discovery message or a discovery response message.

6. The terminal according to claim 3, wherein the processor is configured to invoke the program in the memory to cause the first terminal to further perform:
determining, based on the first link information, whether to select the second communications device as a relay terminal.

7. The terminal according to claim 6, wherein the selection of the relay terminal is further determined based on first configuration information.

8. The terminal according to claim 7, wherein the first link information is used to indicate a quality of a first link between the second communications device and the third terminal, and the first configuration information comprises one or more of following: a first threshold, a second threshold, or a third threshold, wherein
the first threshold is a threshold value of the quality of the first link, the second threshold is a threshold value of a quality of a second link between the second communications device and the first terminal, and the third threshold is a threshold value obtained by performing a first calculation on the quality of the first link and the quality of the second link.

9. The terminal according to claim 8, wherein the second communications device is able to be a relay terminal when one or more of following conditions are met:
in a case that the first configuration information comprises the first threshold, the quality of the first link is greater than or equal to the first threshold;
in a case that the first configuration information comprises the second threshold, the quality of the second link is greater than or equal to the second threshold; or
in a case that the first configuration information comprises the third threshold, a value obtained by performing the first calculation on the quality of the first link and the quality of the second link is greater than or equal to the third threshold.

10. The terminal according to claim 3, wherein the first information comprises one or more of following:
an identity of the third terminal;
a parameter of a first link between the second communications device and the third terminal; or
a type of the parameter of the first link.

11. The terminal according to claim 3, wherein the first information is carried in one or more of following messages: a discovery message, a discovery response message, a PC5 radio resource control (PC5-RRC) message, a sidelink medium access control control element (SL MAC CE), or sidelink control information (SCI).

12. A communications device, wherein the communications device is a second communications device comprising a memory and a processor, wherein the memory is configured to store a program, and the processor is configured to invoke the program in the memory to cause the second communications device to perform:
sending first information to a first terminal, wherein
the first information is used to indicate first link information between the second communications device and a third terminal.

13. The communications device according to claim 12, wherein the first link information is determined by the second communications device.

14. The communications device according to claim 13, wherein the first link information is obtained by measuring a sidelink discovery reference signal received power (SD-RSRP) corresponding to a discovery message or a discovery response message.

15. The communications device according to claim 12, wherein whether to select the second communications device as a relay terminal is determined based on the first link information.

16. The communications device according to claim 15, wherein the selection of the relay terminal is further determined based on first configuration information.

17. The communications device according to claim 16, wherein the first link information is used to indicate a quality of a first link between the second communications device and the third terminal, and the first configuration information comprises one or more of following: a first threshold, a second threshold, or a third threshold, wherein
the first threshold is a threshold value of the quality of the first link, the second threshold is a threshold value of a quality of a second link between the second communications device and the first terminal, and the third threshold is a threshold value obtained by performing a first calculation on the quality of the first link and the quality of the second link.

18. The communications device according to claim 17, wherein the second communications device is able to be a relay terminal when one or more of following conditions are met:
in a case that the first configuration information comprises the first threshold, the quality of the first link is greater than or equal to the first threshold;
in a case that the first configuration information comprises the second threshold, the quality of the second link is greater than or equal to the second threshold; or
in a case that the first configuration information comprises the third threshold, a value obtained by performing the first calculation on the quality of the first link and the quality of the second link is greater than or equal to the third threshold.

19. The communications device according to claim 12, wherein the first information comprises one or more of following:
an identity of the third terminal;
a parameter of a first link between the second communications device and the third terminal; or
a type of the parameter of the first link.

20. The communications device according to claim 12, wherein the first information is carried in one or more of following messages: a discovery message, a discovery response message, a PC5 radio resource control (PC5-RRC) message, a sidelink medium access control control element (SL MAC CE), or sidelink control information (SCI).
